(19) United States
(12) Patent Application Publication
(10) Pub. No.: US 2005/0161117 A1
(43) Pub. Date: Jul. 28, 2005

(54) Corner trimming device

(76) Inventor: Josef Jagg, Berkheim (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 11/011,686

(22) Filed: Dec. 15, 2004

(30) Foreign Application Priority Data
Dec. 16, 2003 (DE) 203 19 515.9
Aug. 16, 2004 (DE) 20 2004 012 786.5

(51) Int. Cl. B27H 1/00; B27M 1/00

(52) U.S. Cl. 144/360

(57) ABSTRACT

The invention refers to a corner trimming device for machining the joint of frames, respectively frame parts, welded from profile parts, where the corner trimming device can move at least in the direction vertically to the plane of the frame defined by the profile parts, as well as along the joint region. A machining tool is arranged on a holding device between two tracers, and each of the two tracers sits close, at least at times, to a profile part, at least at times the tracer can move versus the holding device.

The invention refers to a corner trimming device for machining the joint of frames, respectively frame parts, welded from profile parts, in particular for window or door frames. The device can be moved vertically to the defined plane of the frame, as well as along the joint region and has a machining tool which is arranged between two tracers. Each of the tracers sits close here to one profile part of the frame, respectively door frame.

### BACKGROUND OF THE INVENTION

Corner trimming devices of this kind are known, for example, from the European patent specification 705 659.

It is suggested there that the elongation of the tracer flanks of the tracers approach each other V-shaped, and include the cutting edges of the machining tool, a cutting-off or drawing-off knife.

The tracer flanks, respectively the tracers, are connected actually rigidly with the machining tool. The tracers trace the region which has actually to be machined, which is then machined by the machining tool in such a way that a corresponding chip is cut off in the joint region, in particular in the welding region where an ugly welding bead occurs.

The V-shaped arranged tracers allow the knife to be supported sufficiently on the diagonally extending contours of the profile.

Now it may be the case that the profile which forms the frame, respectively the frame part, has substantially horizontally extending contour sections, making it impossible that these tracers produce a guide for the tool according to the prior art. If, however, the machining tool is not guided, there will be the considerable risk that the tool carries out unintentional movements in the plane of the frame, respectively vertically to it which leads unavoidably to corresponding mismachinings or even damages of the frame, respectively the frame part.

Therefore it is an object of the present invention, coming from the above-cited state of the art, to propose a corner trimming device which, independently from the actual shape of the profile, always achieves a good machining result and avoids producing refuse through mismachinings.

### BRIEF ABSTRACT OF THE INVENTION

According to the invention this problem is solved by suggesting a corner trimming device for machining the joint of frames, respectively frame parts, welded from profile parts, in particular for window or door frames, the corner trimming device being mobile at least in the direction vertically to the plane of the frame defined by the profile parts, as well as along the joint region, a machining tool being arranged between two tracers and each of the two tracers sitting close, at least at times, to a profile part, and the corner trimming device is characterised by the fact that the tracer can move versus the holding device.

The design according to the invention achieves that the tracer can adjust to the holding device according to the conditions of the arrangement of the profiles. The approximate position of the corner of the welded profile parts may be known, this follows, for example, from the fixing stoppers for the profile parts, however, sometimes here certain tolerances of dimensions may occur, which, if there is no suitable compensation as according to the invention, may lead to mismachinings or even to waste. By means of this mobile arrangement of the tracers versus the holding device, in particular before the actual machining, the corner trimming device adjusts itself on its own. Here, of course, the arrangement of the machining tool between the tracers is chosen in such a way that it is on the welded frame, respectively frame part. As the mitre surfaces in the joint region have to be machined accordingly, it is known that the mitre joint is on the bisector of the angle of the meeting profile parts. In other words, the joint profile parts are arranged symmetric with regard to the mitre surface. The joint region which has to be machined is now located at the mitre joint and on the center plane. Consequently the cutting and chip-removing surfaces of the machining tool are located between the two tracers.

The suggestion according to the invention can be used and realised in a number of ways.

In a preferred modification of the invention it is suggested that the machining tool can move versus the tracer.

By means of this modification according to the invention it is achieved that the machining tool sits close exactly to the mitre surface as this position is reached when each of the two tracers sits close to the welded profile parts. The tracers remain in this position while the chip knife removes the welding bead in the mitre region. This means that the chip knife acts because of the propulsion in the direction of the mitre surface, respectively the joint region, and the chip knife moves compared with the tracers sitting close to the profile parts. The knife, respectively the machining tool, remains in the exactly correct position, this is in the mitre region, by means of the permanent contact of the tracers. The different height levels, that means the vertical positions, are reached by the corresponding mobility of the corner trimming device according to the shape of the profile.

In another modification according to the invention it is provided that the tracer and the machining unit form a mobile unit, and can move together versus the holding device. First of all, this modification does not exclude that not even in this mobile unit tracer and machining tool are designed mobile versus each other. This may be set by corresponding brakes or clutches. This arrangement, however, is in particular convenient against the background that this mobile unit has exactly the same geometric arrangement as the joint region, that means the tracers, respectively their tracer surfaces, are arranged at the same angle as the profile parts are orientated to each other, and the center plane of the tracers carries the machining tool, which has to remove the welding bead in the joint region of the mitre joint. The suggestion according to the invention therefore positions the unit altogether versus the holding device, the holding device being moved in the plane rectangular to the plane of the frame, in the direction of the mitre in the joint region.

In a preferred modification of the invention it is provided that laterally beside the machining tool slide faces are provided. In order to avoid an unintentional cutting of the machining tool in the joint region of the welded frame, respectively frame part, suitable slide faces are arranged beside the machining tool. Eventually they define the vertical position of the chip knife (rectangular to the plane of the frame).

The slide faces are arranged beside the cutting edge of the chip knife, for example directly on the chip knife body, or provided in a separate component beside of the chip knife. Conveniently the slide faces are located between the chip knife and the tracer.

The slide faces do not serve for positioning or guiding the knife versus the joint region, respectively the accurate corner position of the machine tool, but they define only the height level of the machining tool during the chip removing machining. The corner guide is carried out by the tracers (which are set back).

In a preferred embodiment of the invention it is provided that the machining tool is designed as chip knife or as circular saw blade. The machining tool is chip-removing. This may, for example, be carried out by a chip-removing chip knife or even a circular saw blade. Even if in the following often a chip knife is mentioned directly, the invention should not be determined to it, instead of the chip knife also the term of a machining tool may be used, the invention is in so far not restricted to the use of a chip knife.

According to an advantageous development of the invention the chip knife is formed V-shaped. The V-shape of the chip knife has the effect that in the mitre region of the welded profile parts, respectively frames, the projecting welding beads can be cut off, respectively removed, properly. The V-shape is also an advantage here as by means of that the resistance occurring during cutting is distributed better.

It is also convenient if the chip knife can move along the joint region, respectively the mitre region. This has the effect that the joint region of the profiles altogether can be machined on the mitre surfaces.

It is an advantage here if the chip knife can move with the corner trimming device rectangular to the plane of the frame. Of course, it is also possible that the chip knife can move with the corner trimming device rectangular to the plane of the frame as well as also at an angle to it. However, for the invention it is sufficient for the time being if the chip knife can move together with the corner trimming device only rectangular to plane of the frame in order to solve the problem according to the invention. The angular mobility is here an advantageous development of the invention.

According to the invention it has been found to be an advantage if the chip knife is designed mobile angular, preferably in a rectangular orientated direction of movement, compared with the tracers. Thus height adjustments for reasons of modifications of the profiles may be carried out without any problems. This goes, of course, also for a spring-supported embodiment where this adjustment is carried out automatically.

It is also an advantage if the chip knife with the tracers can move in the same plane, respectively in a direction of movement orientated parallel to the tracers. This also improves the possibilities of adjustment altogether and offers an even better universal use.

A convenient development of the invention proposes that the chip knife is supported, respectively designed, in such a way that it can, compared with the respective direction of movement, be folded out, adjusted, respectively angled. By means of that also certain adjustments compared with the machining surface may be carried out. The cutting angle of the chip knives versus the machining surface can also be modified, for example because of different materials.

According to a development of the invention the chip knife has a knife region which is designed as cutting edge. It is provided here that the chip knife is provided, for example, with a straight cutting edge.

The chip knife may also have, according to an embodiment of the invention, a resiling cutting edge. It is also an advantage if the cutting edge of the chip knife is chamfered laterally beside the cutting edge, respectively the edge. This is, in particular an advantage if—as proposed according to the invention—not the complete face of the chip knife which faces the profile is designed as cutting edge, but if it is sufficient to design only the knife region as cutting edge which actually has to remove, respectively cut off, the undesired welding bead. Laterally beside the cutting edge it is therefore possible to arrange the already mentioned slide faces which only have the purpose that the knife glides on the profile and does not cut in the profile. This is in a simple manner achieved by the suggestion that—according to the embodiment of the invention—on the chip knife laterally beside the cutting edge the cutting edge, respectively the edge, is chamfered or broken resulting in a slide face which is set back compared with the cutting edge.

According to the invention it is also proposed that the cutting edge of the chip knife projects compared with the elongation of the tracing edge of the tracer sitting close to the frame. This has the consequence that the tracing edges sit always close exactly to the profile, respectively to the two profile parts of the welded profile corner, and the cutting edge of the chip knife has nevertheless sufficient freedom of mobility to remove, respectively cut off, the welding bead in the region of the mitre.

According to the invention it has also been found that it is an advantage if the slide faces are designed in such a way that the chip knife glides on the profile. This has been described before several times.

According to a development of the invention the tracers are spring-supported. This achieves that always an exact close position of the tracers at the profile parts is secured, even if the chip is still possibly in a retracted position. However, the tracers remain in the exact contact position when the chip knife cuts off the welding bead in the region of the mitre joint.

Another aspect of the invention is given by the fact that the tracer has tracing surfaces which are designed in such a way that they can sit close to the frame, respectively the profile parts. This enlarges the tracing contact surface, and improves the accuracy further.

It is also an advantage if the tracing surfaces are, respectively can be, arranged angular, preferably rectangular or—according to the angle of the welded profile parts—orientated to each other. While the one embodiment is convenient for machining rectangular frames or frame parts, the embodiment which has to be arranged angular is meant also for the machining of other frames, shaped, for example, as hexagon where the frame in the joint regions is not orientated to each other at an angle of 90°.

The tracer is, according to a development of the invention, guided mobile on a guide rod, and supported in a tracer bearing, respectively a tracer bedding. As tracer bedding here, for example, a spring is arranged on it the force of which presses the tracer against the profile, respectively the profile parts.

The guide, for example, is designed as round profile and fixed in the tracer bedding itself. By means of that the tracer can be guided very conveniently and accurately in a guide boring which interacts with the guide.

It is also an advantage if the guide is designed in the way of a groove and tongue guide. This may be a simple groove guide, respectively tongue guide, of course, it may also be a more complicated embodiment, for example dovetail grooves and corresponding guides.

Of course, the guide may also be designed, according to a modification of the invention, rail-like.

The spring is, according to a modification of the invention, designed as a flat spiral spring which can be charged with pressure or tension. Of course, the invention is not restricted to that, but it is indeed, and actually in the field of constructing machining tools for plastic machining tools, provided as a convenient modification if the spring is a pneumatic spring.

The spring may be arranged here on its own spring guide. However, it is a simplification of this modification if, for example, the spring is, according to a development of the invention, arranged on the guide for the tracer itself.

It is furthermore convenient if the bottom end of the tracer is arranged in use below the cutting edge of the knife, in particular clearly below the cutting edge of the knife. This has, in particular, the effect that a machining of the profile in the corner region of the profile frame is possible with the invention, even if the frame is comparatively thick.

Advantageously the height of the frame is chosen such that it corresponds at least to the relative thickness of the profile, respectively the vertical distance between the lowest and the uppermost point of the chip knife for machining.

Of course, it is an advantage if the tracer is guided, respectively supported, mobile along the guide according to the length of the mitre surface which has to be machined. This is in particular necessary in order to be able to machine the complete region of the mitre surface.

The invention is not limited to only one embodiment where the chip knife can move compared with the tracers, but also to an embodiment where the chip knife is designed mobile relatively to the corner trimming device.

It is another advantage of the invention that the cutting edge of the chip knife projects compared with the elongation of the tracer edge of the tracer sitting close to the frame. This arrangement has to be seen with regard to the interior of the frame. The engaged chip knife therefore projects versus the tracer, respectively its elongation of the tracer edge. This arrangement is possible as, according to the invention, it is provided that the tracers serve only for positioning the chip knife in the corner region, making also a machining of difficult orientated profile surfaces, in particular if they are horizontal, respectively in the plane of the frame, securely possible, as here also a guide of the knife is carried out.

In a preferred modification of the invention it is provided that the machining tool, for example the chip knife, is supported on a tool carrier mobile in a direction of movement which is parallel to the plane of the frame. By means of this modification it is achieved that the machining tool, which is orientated above the corner trimming device in a plane vertically to the plane of the frame and parallel to the mitre region, can be adjusted accordingly. It is not enough that the knife is only moved in a plane parallel to the mitre, the joint region next to the mitre has to be machined exactly, therefore it is achieved through this suggestion that the machining tool is designed in such a way that it can be adjusted accordingly if it has a corresponding mobility in the plane of the frame. This is either a movement, which is carried out only one-dimensional, or a movement which is designed also two-dimensional parallel to the plane of the frame.

The arrangement here is not restricted to provide only mobility of the machining tool rectangular to the joint region, but it also extends in the same way to the mobility parallel to the joint region. This embodiment is shown, for example, in FIG. 1, while the other modification can be seen in FIG. 4.

An embodiment for that is, for example, the modification according to the invention where the machining tool is supported on a compound rest-like guide in a plane, preferably parallel to the plane of the frame mobile along two directions of movements.

The compound rest-like design has the effect that the machining tool can be moved in one plane in two directions of movement. The directions of movement are here cleverly orientated orthogonal, preferably rectangular. The result of such a design is an optimal adjustment of the machining tool versus the corner of the frame which has to be machined, the machining tool can adjusted optimally to the position of the mitre joint.

In a preferred variant of the invention it is provided that the machining tool is arranged below the tracer. In this modification of the invention it is not significant how the relative position of the tracer surfaces is compared with the machining cutting edges. The arrangement saves space as even very sharp angles can be realised because the different elements are not placed one beside the other, but one above the other. As the tracers serve in particular for adjusting the machining tool before the actual machining, according to this suggestion it is also provided that there is no interaction of the tracer with the profile parts during the actual machining.

A brake has the clever effect that the mobility of tracer and/or machining tool versus the holding device is reduced and even defined. Thus, for example, it is provided that tracer and machining tool are, for example, combined in the already defined mobile unit, and both can move in a plane parallel to the plane of the frame in two directions. By means of defining at least one degree of freedom the mobility is reduced from two degrees of freedom to one degree of freedom. Also the mobility between holding device, on the one hand, and tracer, and/or machining tool, on the other hand, can be eliminated completely, that means tracer, respectively machining tool, are defined versus the holding device. It is also possible to design the brake as friction clutch, and thus provide only a reduction of mobility what is helpful, for example, in the case of a collision or with mismachinings.

According to a modification of the invention it is provided here that the brake acts on at least one of the movements of the machining tool in the compound rest-like guide. Thus it is, for example, provided that the brake does not have to influence both directions of movement, but alternatively only one or the other. This may be an advantage, depending on the field of use. It may also be convenient to eliminate, for example, one degree of freedom in the mobility of the tracer, respectively machining tool, if, for example, a corresponding dimension has already been set fixedly and therefore another variability is not necessary anymore.

Cleverly the brake has one brake disc for each direction of movement. Each brake disc is assigned one direction of movement.

In order to be able to activate the brake a brake drive is provided. Cleverly a brake drive acts on both brake discs reducing the effort for the brake drive accordingly. Of course, it is, alternatively, possible to provide a brake drive for each brake disc.

Constructive advantages are reached if the arrangement is chosen in such a way that the brake drive acts via the first brake disc on the second brake disc. First of all such a design is convenient if only one brake drive is provided. Furthermore such a modification is even suitable if the two brake discs are arranged comparatively close to each other, and a space-saving construction is an advantage.

It is an advantage to provide the brake in the holding device. The holding device is designed, for example, tube-like, and holds in a space-saving way the brake, respectively the brake drive.

Conveniently the brake drive is designed as pneumatic cylinder or as cascade pneumatic cylinder arrangement. The use of a pneumatic cylinder has considerable advantages. In the above cited corner trimming devices, which actually often are used in larger installations for machining synthetic windows or doors often pneumatic ducts, for example for operating holding stoppers for the profile parts and so on are used. Thus no additional expense is necessary for the pneumatic system.

In a particular modification also a cascade pneumatic cylinder is suggested by means of which through a larger number of pistons arranged one after the other, the effective piston surface is enlarged considerably despite the given diameter of the holding device (which is for example tube-like). This makes a larger braking power possible.

Of course, it is alternatively provided to design the brake drive electric, electro-magnetic, or hydraulic, and so on.

In another modification according to the invention it is provided that the brake can be activated, respectively deactivated, for one or the other direction of movement. The use of the brake discs is made possible or excluded in a suitable way, having the effect that the brake can be used for the direction of movement or not. This improves the variability of the complete corner trimming device according to the invention correspondingly, because there are also cases of application where a too high mobility of the machining tool, respectively the holding devices, is obstructing. The deactivation of the brakes is here designed in such a way that, for example, a suitable adjustment can be chosen and accordingly be fixed. The activation, respectively deactivation, is carried out here, for example by hand or automatically, respectively by the machine control.

Conveniently the brake is equipped with a braking unit which is arranged in the compound rest-like guide, and which serves, on the one hand, as abutment for the first brake disc, and, on the other hand, forms the second brake disc. The braking unit receives as abutment the force impressed by first brake disc, and by compressing the first brake disc on the abutment (the braking unit) the first direction of movement is eliminated. The braking unit is supported mobile, and can press on another, second abutment with its second brake disc, braking, respectively defining, also the movement in this second direction of movement. Cleverly for that purpose the braking unit as described is used in the compound rest, that means the guides which cross each other cleverly rectangular. By means of this central arrangement in the compound rest-like guide the invention is used effectively and space-saving.

Cleverly it is provided that the tool carrier is part of the compound rest. Thus the tool carrier is guided, for example, mobile in a first direction on the holding device, and has itself the second, orthogonal axis, defining the compound rest guide in the sense of the invention.

Here it is, according to another modification of the invention, provided that the corner trimming device has two machining tools, a first machining tool being held by the tool carrier and a second machining tool being held by the compound rest-like guide. In this connection it is referred, for example, to FIG. 4. The two knives are optimised according to their field of use, the bottom one, in this case the second knife, carrying out a vertical movement, and an accurate positioning, in particular rectangular to the joint region (of the mitre) within the plane of the frame (for machining the interior corner) being an advantage.

The other, second machining tool is, in contrast to that, held by the compound rest-like guide, and has additionally another mobility, for example rectangular. This mobility is supported, for example, by a spring and used for guiding the machining tool sufficiently with power against the surface of the profile in the joint region.

Here, cleverly, both machining tools, that means the first and the second tool, are arranged below the tracer.

According to another modification of to the invention it is provided here that the corner trimming device, respectively the holding device, is guided by a numeric control according to the shape of the profile for machining over the joint region. The numeric and computer control has the shape of the profile and follows exactly this shape. An additional, expensive tracing of the surface is not significant in this machining step. The shape of the contour is taken from the store and given to the computer control accordingly.

In particular the use of a guide through the tracers is saved when a numeric control is used for moving the corner trimming device in the joint region.

In a preferred modification of the invention it is provided that the brakes are released before machining for adjusting the tracer, respectively the machining tool, versus the holding device, and the brake is fixed during machining. The arrangement is here chosen in such a way that tracer, respectively machining tool, have a certain range of adjustment in the plane of the frame in order to position in particular the machining tool optimally, so that it, during a movement of the complete device, for example along the shape of the contour given by the numeric control, machines exactly the joint region (the mitre).

The invention does not only refer to a corner trimming device as described in the beginning, but it refers in the same way also to a method for machining, in particular trimming the joint of frames, respectively frame parts, formed by profile parts, in particular for window or door frames, where a machining tool is moved between two tracers by a holding device in the joint region.

In the European patent specification described in the beginning the two tracers sit close laterally beside the cutting edge during the machining process. In horizontal sections machining with the method according to the state of the art is not possible. The object of the present invention therefore also includes a method for machining, in particular for trimming the joint of frames and frame parts formed by profile parts, where, independently from the actual design of the profile, always a good machining result shall be reached.

This problem is solved by coming from a method as described above, where the tracer(s) are mobile compared with the holding device before the machining in such a way, that by setting the tracer to the profile parts the tracer is adjusted versus the holding device and the machining is carried out after the adjustment.

The object of the tracers according to the method of the invention is different from the one in the solution according to the state of the art. In the first modification according to the invention the tracer remains during the complete machining at the respective profile parts, as it is clearly shown, for example, in FIG. 1. The movement of the machining tool, respectively the chip knife, is carried out independently from the position of the tracer. In the other modification the tracer will not sit close during machining, that means after adjustment, anymore to the respective profile parts.

The two before-mentioned conceptions have in common that the tracers are used for approaching in a suitable way in the corner region to the profile parts, and thus adjust the machining tool. In a preferred modification of the method it is provided that, after the tracer has been adjusted versus the holding device, the position between the tracer and the holding device has been fixed by a brake. By means of this suggestion the relative position of the tracer (of course, also the machining tool) and the holding device is “stored mechanically”. Eventually the correct position of the machining tool versus the mitre is found by this step so that during the following movement the machining tool is guided exactly in the plane which stands rectangular on the plane of the frame, and comprises the mitre region. Tolerances of dimensions, which may always occur with such machinings, are eliminated. Conveniently it is suggested then that during machining the tracers do not sit close to the profile parts. In the other modifications, in particular in the solution according to the state of the art, the tracers sit close during machining and grind possibly over the visible surfaces of the frame. This may lead to optical impairments. If, however, the tracers are removed from the profile parts, according to the suggestion of the invention, so that they do not sit close anymore—the position of tracer/machining tool to the holding device is braked—an optimal machining is following without the additional risk of damage.

Advantageously it is provided that during machining the corner trimming device, respectively the holding device, is guided by a numeric control, that means a computer control which follows the shape of the profile in the joint region. The numeric control knows the cross section of the profile. Depending on the design of the mitre now the concrete shape of the contour may be slightly differing as a rectangular mitre section corresponds with a cross section, however, a corresponding distortion has to be taken into consideration for a mitre section less than 45°. However, this may be investigated easily with a given profile cross section by the control, and that is for each corner angle of the meeting profile parts. This modification according to the invention achieves that also a machining in very sharp angle is possible as no obstructing tracers have to be supplied additionally during machining in the narrow corner region, but only the chip removing tool has to be guided, respectively moved, accordingly.

In this connection it is in particular pointed out that all features and characteristics, but also all procedures, described in connection with the device can be transmitted and are seen as to be useful and also disclosed in the sense of the invention accordingly with reference to the formulation of the method according to the invention. The same goes also vice versa, that means, constructive characteristics, that means characteristics according to the device mentioned only with reference to the method may also be taken into consideration in the frame of the device claims and can be claimed and count also as belonging to the invention and disclosure.

### BRIEF DESCRIPTION OF THE DIFFERENT VIEWS OF THE DRAWINGS

In the drawing the invention is shown schematically. In the drawings:

FIGS. 1, 2, 3, 4 each a three dimensional view of the corner trimming device according to the invention,

FIG. 5 a vertical section through a corner trimming device according to the invention.

### DETAILED DESCRIPTION OF THE PREFERRED EMBODIMENT

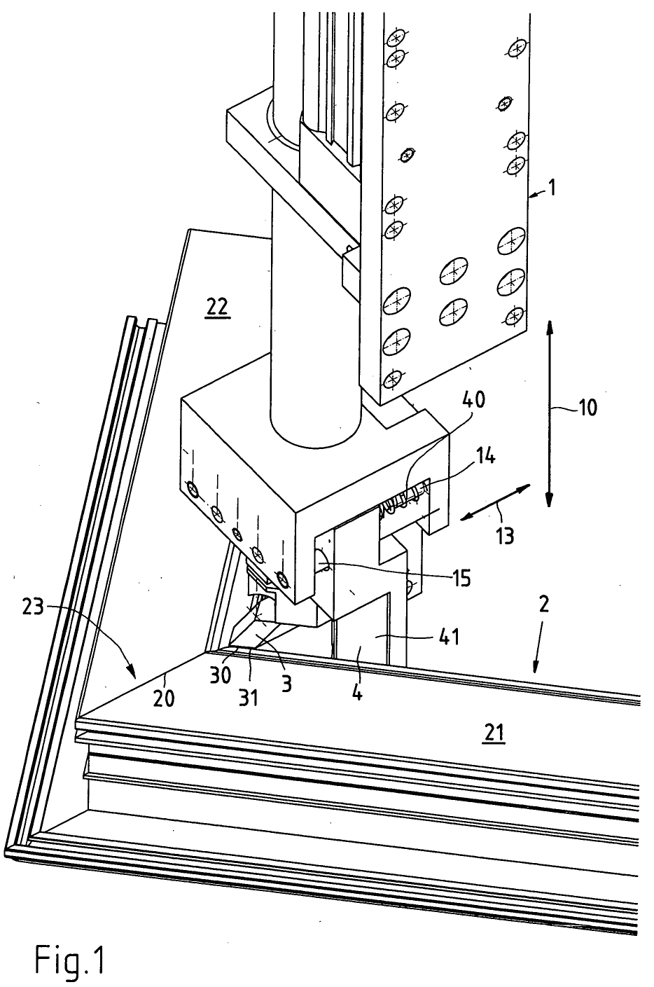

In FIG. 1 the corner trimming device 1 according to the invention is shown. It can be seen clearly how the corner trimming device removes in the corner region 23 of the frame 2 the welding bead occurring during welding the profile parts 21, 22 in the mitre region, respectively joint region 20. Because of the welding of the profile parts 21, 22, and the following assembly a welding bead occurs which projects outward which has to be removed by the corner trimming device at least in the corner region.

Even if in the following a frame is mentioned the invention is not restricted to the machining of a frame, but it can also in the same way and the same sense be used for frame parts. Thus the invention is only described on a frame, however, comprises in the same way also a partial frame or frame parts.

The two profile parts 21, 22 welded together define plane of the frame which, as a rule, is orientated, at least for machining purposes, horizontally. However, there is also a machining standing up where the plan of the frame is then orientated vertically or diagonally. The corner trimming device 1 can move at least along two axes which preferably are orthogonal or rectangular to each other. The first axis allows a movement in the plane of the frame, this indicated by double arrow 13. Conveniently this movement 13 is orientated in such a way that the chip knife 3 can move along the joint region 20, respectively the mitre surface 20.

Furthermore the corner trimming device can move rectangular to the plane of the frame, this is indicated by double arrow 10. By means of that it is possible that the chip knife carries out even diagonal machinings or machinings which have to be carried rectangular to the plan of the frame.

For removing the welding bead a chip knife 3 is provided on the corner trimming device. The chip knife 3 is designed, in the embodiment shown here, V-shaped. However, it is also possible to realise another arrangement of the cutting edge, for example a straight cutting edge or a resiling cutting edge.

It has to be taken into consideration here that not the complete chip knife face facing the profile is designed as cutting edge, but it is often sufficient to design only the knife region as cutting edge 30 which has actually to remove the undesired welding bead. Laterally beside the cutting edge 30 it is therefore possible to arrange slide faces 31 (see FIG. 1) which make the knife gliding on the profile and not cutting in the profile. This is simply achieved by chamfering or breaking the cutting edge, respectively the edge, on the chip knife laterally beside the cutting edge 30, resulting in a slide face 31 set back versus the cutting edge 31.

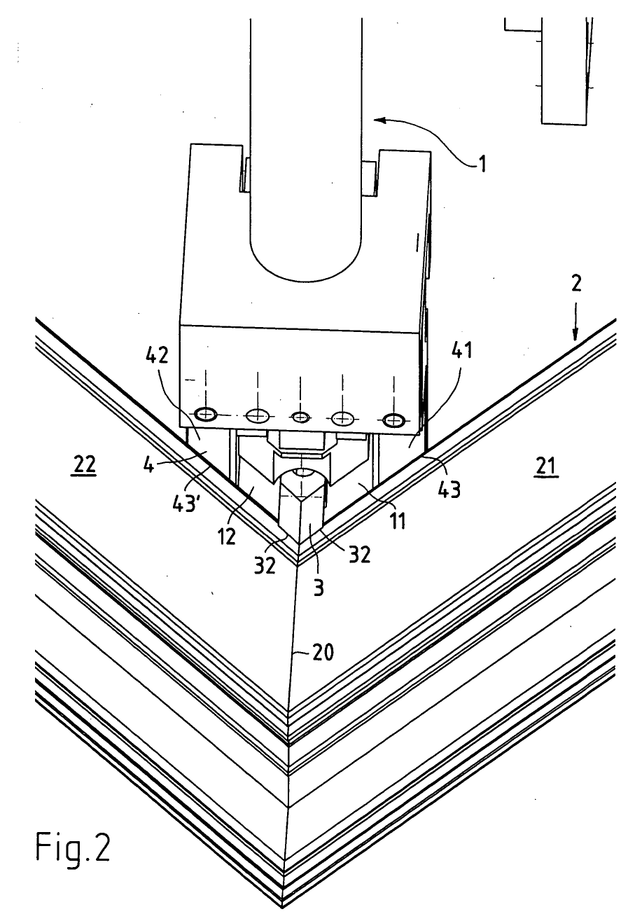

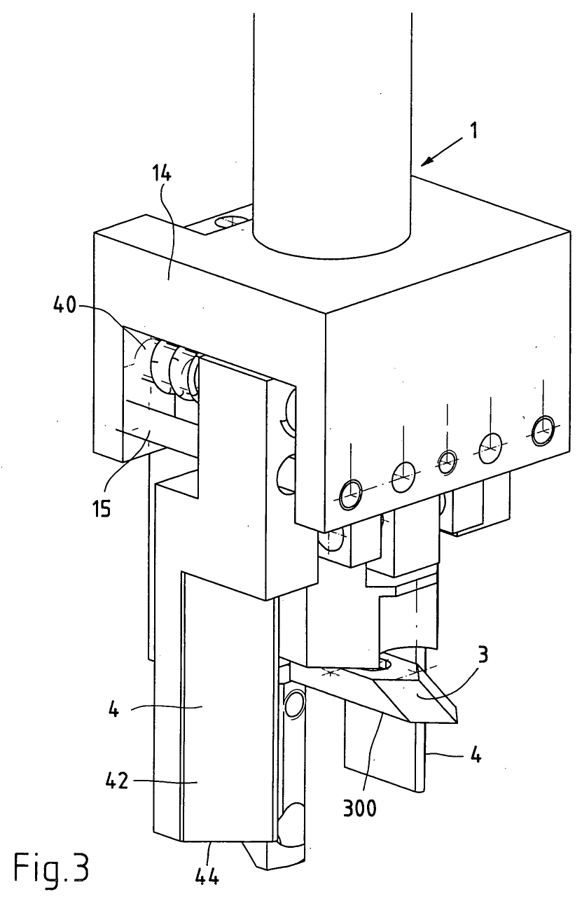

The corner trimming device 1 has two tracers 4. They are arranged in such a way that the chip knife 3 is located between the two tracers 4. This is shown, for example, in FIG. 2. The knife 3 is positioned exactly in the corner region of the frame 2, the two tracers 41, 42 sit close to the profile parts 21, 22 which are welded at the corners, the tracer 41 sitting close to the profile 21, the tracer 42 sitting close to the profile 22. It can be seen clearly that the front edge 32 of the chip knife 3 projects compared with the elongation of the tracer edges 43, 43′ in such a way that it intrudes the corner region 23 of the frame 2. This is achieved by the fact that the tracers 4 are supported mobile compared with the chip knife 3. For that purpose a spring arrangement is chosen, as can be seen in FIG. 1 or in FIG. 3. The tracer 4 is guided on a guide rod 15 on the tracer support 14 of the corner trimming device 1. By means of the spring 40 the tracer 4 is pressed forward against the profile. If a movement of the corner trimming device forward is carried out, the tracer 4, if it sits close to the profile parts 21, 22, is pushed back against the force of the spring 40, however, the chip knife 3, however, follows the movement of the corner trimming device 1 and machines accordingly the profile region. The invention includes also an arrangement where the chip knife can move relatively to the corner trimming device.

In FIG. 3 it can also be discerned clearly that the bottom end 44 of the tracers 4 are arranged well below the bottom side of the knife 300. This results in the considerable advantage that a machining of the profile in the corner region is possible by means of the invention, even if the frame is comparatively thick, that means that a long distance is machined rectangular to the plane of the frame by the chip knife. Eventually the height of the tracer 4 is chosen in such a way that it corresponds at least with the relevant thickness of the profile, and the relevant thickness of the profile is defined by the fact that it corresponds with the distance in which the chip knife 3 on one side of the frame in the corner region has to machine the corner region. As, for example, the visible surface of the frame 2 has to machined, here the relevant height is not the thickness of the profile altogether, but only the vertical distance between the lowest and the highest machining point of the chip knife 3. As, however, the height of the tracer 4 is chosen as described, it is secured that the tracer 4 is always reliably in the corner region of the welded profile parts 21, 22.

The mobility of the tracer 4 along the guide 15 is dimensioned in such a way that the desired machining in the direction of the plane of the frame, respectively the mitre surface, is possible.

In FIG. 1 it is indicated that there are slide faces 31 at the chip knife 3 beside the cutting edges 30.

In FIG. 2 also slide faces 11, 12 are provided which are arranged between the chip knife 3 and the tracers 4, 41, 42.

The use of the corner trimming device according to the invention is as follows. After the frame 2, respectively the partial frame, has been positioned, the corner trimming device 1 is positioned along the two axes in the corner region 23 of the frame 2. First of all the corner trimming device is angled parallel to the plane of the frame in the direction of the plane of the frame (double arrow 13) to the internal corner, until each of the tracers 41, 42 sits close to the profile parts 21, 22. Then the corner trimming device 1 is lowered orthogonal rectangular so far that the chip knife 3 is supported at least in the joint region 20, respectively is available for use. Here the chip knife 3 projects slightly compared with the elongation of the tracer edges. The corner region which is below it is machined by other chip removing tools. After the corner trimming device has been positioned in this way a propulsion is carried out in the direction of the external corner along double arrow 13, and therefore the tracer 4 is supported on the profile parts 21, 22, and is forced back compared with the moving forward chip knife 3. The chip knife 3 cuts in the welding bead which has to be removed and removes it. The slide faces arranged beside the chip knife 3 prevent the knife 3 from cutting in too deeply. Simultaneously the slide faces 11, 12, 31 help the knife following different levels of the profile (parallel to the direction of movement 10 rectangular to the plane of the frame). The freedom of mobility in the direction of the plane of the frame (arrow 13) as well as the height of the tracers 4 is dimensioned in such a way that a complete removal of the undesired welding bead in the corner region is carried out in one operational step.

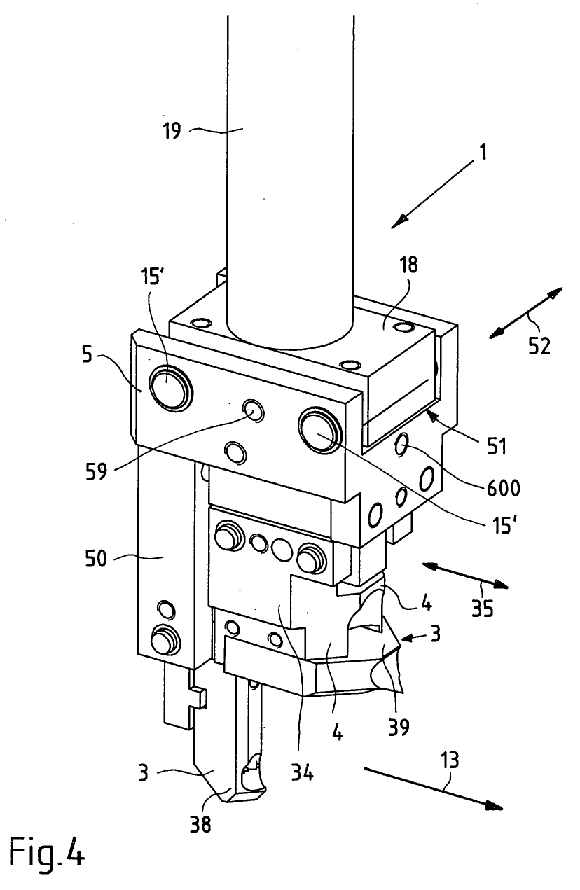

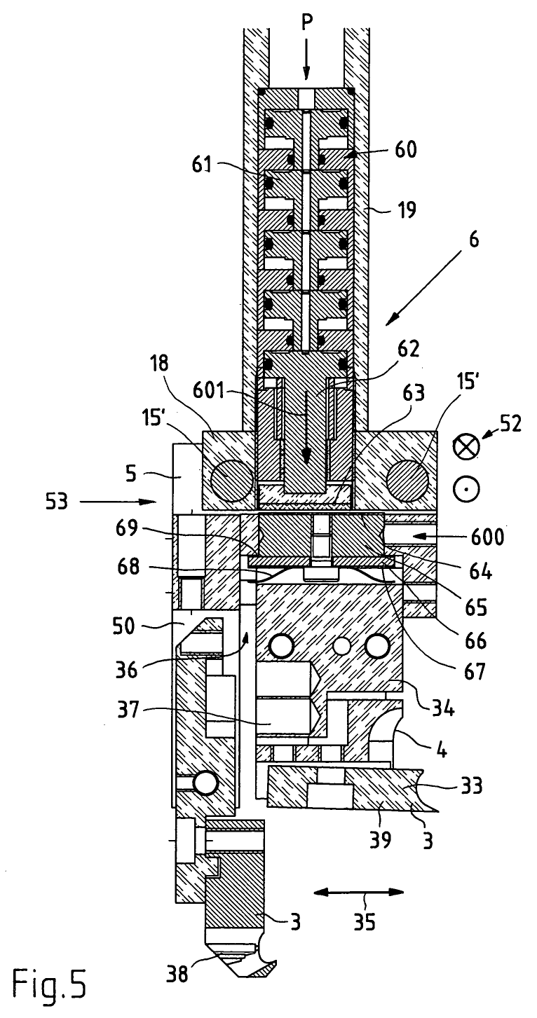

In FIGS. 4, 5 another embodiment of the trimming device according to the invention is shown.

At the bottom end of a holding device 19 a holding block 18 is provided. The holding block 18 carries on the right and the left hand side, respectively at the front and back, compared with the holding device 19, guide rods 15′.

The tool carrier 5 is supported mobile on the guide rods 15′. The guide rods 15′ are orientated differently compared with the guide rods 15 of FIG. 1. According to the solution in FIG. 1 the guide rod 15 is arranged essentially parallel to the direction of movement, respectively the direction of machining, 13. (parallel to the plane of the frame), in the solution according to FIG. 4, respectively FIG. 5, the guide rods 15′ are orientated rectangular to it.

The upper part of the tool carrier 5 is designed U-shaped 51, the U being arranged around the holding block 18. The guide rods 15′ are embedded accordingly in the tool carrier 5, in particular in the vertical limbs of the U-shaped receiver 51.

Furthermore the tool carrier 5 is formed like a L, seen in the view (for example FIG. 5), the upper, short limb being formed by the U-shaped receiver 51 and the a vertical part 50 joining downward.

Because of the guide rods 15′ the tool carrier 5 can move rectangular to the direction of movement 13 of the corner trimming device 1. This mobility is indicated by double arrow 52.

The tool carrier is also part of the compound rest-like guide 53. A compound rest is characterised by the fact that it allows movement in one plane, as a rule in directions orientated orthogonal (ideally rectangular to each other). A first direction of movement is given by the arrangement of the guide rods 15′, the direction of movement 52 is rectangular to the main direction of movement 13 of the corner trimming device (this is additionally superimposed by a vertical part 10, depending on the shape of the profile). The second direction is parallel to the direction of movement 13. On the bottom side of the U-shaped receiver 51 a guide is provided which is designed rectangular to the longitudinal extension of the guide rod 15′.

Via the second guide (not shown) which allows the direction of movement 35 (parallel to the main direction of movement 13 of the corner trimming device), the tool carrier 34 is held and guided. The tool carrier 34 can be supported on its back side on the vertical part 50 of the tool carrier 5, for example by suitable springs.

The tool carrier 34 has, from the top to the bottom, first of all, the tracers 4 which are orientated angular according to the arrangement of the welded profile parts, because below the tracers 4 the machining tool 3, for example a chip knife 33, is connected. The second chip knife 39 shown here is provided in particular for machining in the direction of the plane of the frame 13.

The vertical part 50 of the tool carrier 5 carries on its bottom end also a machining tool, namely the first knife, respectively chip knife 38. Its preferred direction of movement is vertically upwards, rectangular to the main direction of movement 13, also rectangular to the plane of the frame. This knife 38 serves, for example, for machining vertically extending corner regions, in particular interior corner regions.

Via the tracers 4 not only the second knife 39, but also the first knife 38 is positioned exactly. In the frame of the horizontal mobility (in the direction of double arrow 52) the tracer 4 is positioned in such a way in the interior corner of the profile that both tracers 4 are connected with the profile parts and sit close to them. The resulting horizontal component of movement in the direction of double arrow 52 is effective for the first knife 38 as well as for the second knife 39.

It is an advantage of the invention that by this one tracing two knives are positioned, in particular for the machining of the internal corner.

Simultaneously, the tool carrier 34 can recede also during the tracing approach, according to double arrow 35, possibly contact switches being provided which transmit to the control that the holding device is in position. The spring support of the tool carrier 34 has the effect here that a component of movement in the direction of double arrow 35 is transferred in a component of movement rectangular to it in the direction of movement of double arrow 52. Therefore an accurate evening out and also centering of the machining tool 3 on the holding device 19 follows.

In FIG. 5 a vertical section through the corner trimming device of FIGURE a according to the invention is shown. The holding device 19 is shaped like a tube and hollow on the inside. This is convenient as by means of that, without wasting additional expensive constructive space, a brake 6, respectively the brake drive 60 for brake 6, can be disposed in the interior of the tube-like holding device 19.

The brake drive 60 shown here is designed as pneumatic cylinder arrangement 61. A number of pistons arranged like a cascade one behind the other enlarge the effective piston surface considerably, without causing widening the tube. The pressure P of a compressed air supply acts here in a centrally arranged channel, and via grooves arranged in the top sides of the pistons on the piston surface, the piston rod of the top one standing on the piston of the bottom pneumatic cylinder. On impinging with pressure thus a considerable power (up to 1,000 Newton) is reached with suitable dimensioning and arrangement of the cascades; if the cascades are even larger dimensioned or if there are even more of them, an even larger power can be reached. The result is a movement of the brake piston 62 vertically downward according to arrow 601. The brake piston 62 is here arranged in the bottom region of the holding device 19, and gets its power through its own pressure impingement with compressed air P, as well as the common pressing of the pistons arranged above it.

The braking piston 62 intrudes here into the holding block 18 between the two guide rods 15′.

Below the brake piston 62 a first brake disc 63 is arranged which is pressed by the movement 601 of the brake piston 63 to an abutment 64. By means of that it is possible to define the movement 52 (vertically to the paper plane) of the tool carrier 5 versus the holding device 19.

The abutment 64 which interacts with the first brake disc 63 is part here of the braking unit 65 which is mounted very centrally in the tool carrier 5. The tool carrier 5 forms here a compound rest-like guide 53, making a movement of the machining tools 3 in the paper plane (according to double arrow 35) as well as rectangular to it, that means rectangular to the paper plane (according to the symbols 52), possible.

The braking unit 65 acts as abutment 64 for the first brake disc, that means for defining the movement in direction of the arrows 52, as well as the second brake disc 66 in order to define or restrict the movement in the paper plane (double arrow 35) in interaction with the second abutment 67.

For that purpose the tool carrier 5 has a guide on which the tool carrier 34 can move according to the orientation of the double arrow 35. The possible lift in the direction of double arrow 35 is the width of the gap 36, the tool carrier 34 is set in the example shown here so that it can shift completely to the right hand side.

Here the tool carrier 34 has two spring receivers 37 on the back side in the direction of the vertical part 50, so that the tool carrier 34 is able to press itself away from the tool carrier 5, and the arrangement can also recede against this power.

The second brake disc 66 has a larger diameter as the braking unit 65. At the guide of the braking unit 65 in the tool carrier 5 here a stopper 69 is provided which restricts the movement of the brake disc 66 upward, because of the leaf spring 68. The centrally arranged screw keeps the brake disc 66 and the braking unit 65 together. Now the brake drive 60 has to press against the power of the leaf spring 68 in order to eliminate also the second movement (in the direction of double arrow 35). For that purpose then the second brake disc 66 presses on the abutment 67.

At the tool carrier 5, on the right hand side in FIG. 5, below the holding block 18, a boring 600 with a thread is provided. The braking unit 65 has a circumferential groove. A screw screwed into the boring 600 presses into this circumferential groove, and defines the mobility of the braking unit in such a way that it cannot press anymore the second brake disc 66 towards the second abutment 67 against the power of the spring 68.

By means of that the brake can be switched off, respectively deactivated, for the direction of movement according to double arrow 35.

Similarly this is also possible for the other direction of movement according to double arrow 52. In the U-shaped receiver 51 (see FIG. 4) locking screws 59 are provided roughly in the center between the two guide rods 15′ on the front and back side. By means of these locking screws 59 the position compared with double arrow 52 of the tool carrier 5 versus the holding device 19 is defined and the brake would have no effect here. The braking effect then is only active on the second bottom brake in the direction of double arrow 35.

The way of manufacturing in a corner trimming device according to the invention and shown in FIGS. 4 and 5 is as follows.

After the frame part 2, the corner region of which has to be trimmed, has been clamped, the holding device 19, respectively the corner trimming device 1 is positioned accordingly. Here, first of all, the corner trimming device 1 is lowered so far that the knives 3, 33 are located below the frame 2 so that the tracers 4, which are set back slightly compared with the knives, but are arranged above them, come into contact with the profile parts 21, 22. Because of the “floating” support, the arrangement of the tracers 4 and the machining tool 3 is adjusted versus the holding device 19 and centered. This position is then defined by the brake 6. The corner trimming device 1 is then moved back a bit so that the second knife 39 is released. Possibly, first of all, the vertical (interior) region is machined by the first knife 38. After that then the second knife 39 is used for the essentially horizontal, respectively diagonal, machining, the guide of this knife being machine controlled, for example numeric controlled, and the corresponding contour figures being taken from the store, and the control controlling and moving the knife according to the given figures.

The invention is in particular suited to be used with profiles which have internal curves, these curves being orientated also in the plane of the frame (also parallel to the direction of movement 13). The invention can be used in particular for frames with overlappings.

Although the Invention has been described by exact examples which are illustrated in the most extensive detail, it is pointed out that this serves only for illustration, and that the invention is not necessarily limited to it because alternative embodiments and methods become clear for experts in view of the disclosure. Accordingly changes can be made without departing from the contents of the described invention.

1. Corner trimming device for machining the joint of frames, respectively frame parts, welded from profile parts, in particular for window or door frames, the corner trimming device being movable at least in the direction vertically to the plane of the frame defined by the profile parts, as well as along the joint region, a machining tool being arranged on a holding device between two tracers, and each of the two tracers sitting close, at least at times, to a profile part, characterised in that the tracer (4) can move, at least at times, versus the holding device.

2. Corner trimming device according to claim 1, characterised in that the machining tool (3) can move versus the tracer (4).

3. Corner trimming device according to claim 1, characterised in that the tracer (4) and the machining tool (3) form a mobile unit, and can move together versus the holding device (19).

4. Corner trimming device according to claim 1, characterized in that laterally beside the machining tool (3) slide faces (31) are provided.

5. Corner trimming device according to claim 1, characterized in that the machining tool (3) is designed as chip knife (33) or as circular saw blade.

6. Corner trimming device according to claim 1, characterized in that the machining tool (3) is designed as chip knife (33), and the chip knife (33) is designed V-shaped.

7. Corner trimming device according to claim 1, characterised in that the machining tool (3) is designed as chip knife (33), and the chip knife (33) is supported, respectively designed, in such a way that it can, versus the respective direction of movement of the corner trimming device (10, 13), be folded out, adjusted, respectively angled.

8. Corner trimming device according to claim 1, characterised in that the machining tool (3) is designed as chip knife (33), and the chip knife (33) has a resiling blade (30).

9. Corner trimming device according to claim 1, characterised in that the machining tool (3) is designed as chip knife (33), and the blade of the chip knife (33) is chamfered laterally beside the blade (30), respectively the edge.

10. Corner trimming device according to claim 1, characterised in that the machining tool (3) is designed as chip knife (33), and the blade (30) of the chip knife (33) projects with regard to the elongation of the tracer edge (43, 43′) of the tracer (4) sitting close to the frame.

11. Corner trimming device according to claim 1, characterised in that slide faces (31) are provided laterally beside the machining tool (3), and the slide faces (31) are set back compared with the blade (30) of the machining tool (3).

12. Corner trimming device according to claim 1, characterised in that the tracer (4) is spring-supported.

13. Corner trimming device according to claim 1, characterized in that the tracer (4) has tracing faces (41, 42) which can be set close to the frame, respectively the profile parts (21, 22).

14. Corner trimming device according to claim 1, characterized in that the tracer (4) has tracing faces (41, 42) which can be set close to the frame, respectively the frame parts (21, 22), and the tracer faces (41, 42) are arranged, respectively may be arranged, orientated to each other angular, preferably rectangular or according to the angle of the welded profile parts (21, 22).

15. Corner trimming device according to claim 1, characterised in that the tracer (4) is guided mobile on a guide rod (15) and supported in a tracer support (14).

16. Corner trimming device according to claim 1, characterized in that the tracer (4) is guided mobile on a guide rod (15) and supported in a tracer support (14), and on the tracer support (14) a spring (40) is arranged the force of which presses the tracer (4) against the profile, respectively the profile parts (21, 22).

17. Corner trimming device according to claim 1, characterised in that the tracer (4) is guided mobile on a guide rod (15) and supported in a tracer support (14), and the spring (40) is arranged on the guide (15).

18. Corner trimming device according to claim 1, characterized in that the tracer (4) is guided mobile on a guide rod (15) and supported in a tracer support (14), and the spring (40) has its own spring guide.

19. Corner trimming device according to claim 1, characterised in that the bottom end (44) of the tracer (4) is arranged, when used, below the cutting edge (33), in particular clearly below the cutting edge (33).

20. Corner trimming device according to claim 1, characterised in that the level of the tracer (4) is chosen in such a way that it corresponds at least with the relative thickness of the profile, respectively the vertical distance between the lowest and the uppermost point of the chip knife (3) for machining.

21. Corner trimming device according to claim 1, characterised in that the tracer (4) is guided, respectively supported, mobile along the guide (15) according to the length of the mitre surface (20) which has to be machined.

22. Corner trimming device according to claim 1, characterised in that the machining tool (3) is designed mobile relatively to the corner trimming device.

23. Corner trimming device according to claim 1, characterised in that the machining tool (3) is supported mobile on a tool carrier (5) in one direction of movement is parallel (35, 52) to the plane of the frame, preferably rectangular (52) to the joint region.

24. Corner trimming device according to claim 1, characterised in that the machining tool (3) is supported mobile on a compound rest-like (53) guide in a plane, preferably parallel to the plane of the frame, along two directions of movement (35, 52).

25. Corner trimming device according to claim 1, characterised in that the machining tool (3) is arranged below the tracer (4).

26. Corner trimming device according to claim 1, characterised by a brake (6) for reducing or defining the mobility of the tracer (4) and/or the machining tool (3) versus the holding device (19).

27. Corner trimming device according to claim 1, characterized in that a brake (6) is provided for reducing or defining the mobility of the tracer (4) and/or the machining tool (3) versus the holding device (19), and the brake (6) acts on at least one of the movements (35, 52) of the machining tool (3) in the compound rest-like guide (53).

28. Corner trimming device according to claim 1, characterized in that a brake (6) is provided for reducing or defining the mobility of the tracer (4) and/or the machining tool (3) versus the holding device (19), and the brake (6) has one brake disc (63, 66) for each direction of movement.

29. Corner trimming device according to claim 1, characterised in that a brake (6) is provided for reducing or defining the mobility of the tracer (4) and/or the machining tool (3) versus the holding device (19), and the brake (6) has a brake disc (63, 66) for each direction of movement, and one brake drive (60) is provided for both brake discs (63, 66).

30. Corner trimming device according to claim 1, characterised in that a brake (6) is provided for reducing or defining the mobility of the tracer (4) and/or the machining tool (3) versus the holding device (19), and the brake (6) has one brake disc (63, 66) for each direction of movement, and a brake drive (60) acts via the first brake disc (63) on the second brake disc (66).

31. Corner trimming device according to claim 1, characterised in that a brake (6) is provided for reducing or defining the mobility of the tracer (4) and/or the machining tool (3) versus the holding device (19), and the brake (6) has one brake disc (63, 66) for each direction of movement, and a brake drive (60) is provided for the brake discs (63, 66), and the brake (6), respectively the brake drive (60), is provided in the holding device (19).

32. Corner trimming device according to claim 1, characterised in that a brake (6) is provided for reducing or defining the mobility of the tracer (4) and/or the machining tool (3) versus the holding device (19), and the brake (6) has one brake disc (63, 66) for each direction of movement, and a brake drive (60) is provided for the brake discs (63, 66), and as brake drive (60) a pneumatic cylinder, in particular a cascade pneumatic cylinder arrangement (61) is provided.

33. Corner trimming device according to claim 1, characterised in that a brake (6) is provided for reducing or defining the mobility of the tracer (4) and/or the machining tool (3) versus the holding device (19), and the brake (6) can be activated, respectively deactivated, for one or the other direction of movement.

34. Corner trimming device according to claim 1, characterized in that a brake (6) is provided for reducing or defining the mobility of the tracer (4) and/or the machining tool (3) versus the holding device (19), and the brake (6) has one brake disc (63, 66) for each direction of movement, and the brake has (6) has a braking unit (65) which is arranged in a compound rest-like guide (53), and which, on the one hand, serves a abutment for the first brake disc (63) and, on the other hand, forms or carries the second brake disc (66).

35. Corner trimming device according to claim 1, characterised in that the machining tool (3) is supported mobile on a tool carrier (5) in a direction of movement parallel (35, 52) to the plane of the frame, and the tool carrier (5) is part of the compound rest guide (53).

36. Corner trimming device according to claim 1, characterised in that the corner trimming device (1) has two machining tools (3, 38, 39), a first machining tool (38) being held by a tool carrier (5), and a second tool (39) being held by a compound rest-like guide (53).

37. Corner trimming device according to claim 1, characterised in that the corner trimming device (1), respectively the holding device (19), is guided by a NC control according to the shape of the profile for machining over the joint region (20).

38. Corner trimming device according to claim 1, characterised in that a brake (6) is provided for reducing or defining the mobility of the tracer (4) and/or the machining tool (3) versus the holding device (19), and the brake (6) is released before machining, and for adjustment of tracer (19), respectively machining tool (3), versus holding device (19) and during machining the brake (6) is fixed.

39. Method for machining, in particular trimming of the joint of frames, respectively frame parts, formed by profile parts, in particular for window or door frames, where a machining tool is moved between two tracers through a holding device in the joint region, characterised in that before machining the tracer is mobile versus the holding device in such a way that, through contact of the tracers to the profile parts, the tracer is adjusted versus the holding device, and the machining is carried out after adjusting.

40. Method according to claim 39, characterised in that, after the tracer has been adjusted versus the holding device, the position between the tracer and the holding device is defined by a brake.

41. Method according to claim 39, characterised in that during machining the tracers do not sit close to the profile parts.

42. Method according to claim 39, characterised in that during machining the corner trimming device, respectively the holding device, is guided by a NC control, following the shape of the profile in the joint region.
